(19) United States
(12) Patent Application Publication
(10) Pub. No.: US 2017/0170998 A1
(43) Pub. Date: Jun. 15, 2017

(54) PRE-COMBINER INTERFERENCE REMOVAL

(71) Applicant: NOKIA SOLUTIONS AND NETWORKS OY, Espoo (FI)

(72) Inventors: Sathiaseelan SUNDARALINGAM, Camberley (GB); Srinivasan SELVAGANAPATHY, Bangalore (IN); Muneender CHIRANJI, Hyderabad (IN); Olli Juhani PIIRAINEN, Oulu (FI)

(21) Appl. No.: 15/086,777

(22) Filed: Mar. 31, 2016

(30) Foreign Application Priority Data
Dec. 11, 2015 (IN) 3697/DEL/2015

(51) Int. Cl. H04L 25/03; H04L 1/08

(52) U.S. Cl. CPC H04L 25/03993; H04L 1/08

(57) ABSTRACT

Interference may affect numerous communication systems. Thus, certain wireless communication systems that rely on combining transmitted repetitions of information may benefit from interference removal techniques, such as those that provide pre-combiner interference removal. A method can include receiving, from a transmitter, multiple repetitions of a same information sent from the transmitter over a channel. The method can also include removing interference from the respective repetitions. The method can further include combining the interference-removed repetitions. The method can additionally include performing channel estimation based on the combined interference-removed repetitions. The method can also include retrieving information corresponding to the same information sent in the multiple repetitions based on the channel estimation and combined interference-removed repetitions.

### BACKGROUND

Field

Interference may affect numerous communication systems. Thus, certain wireless communication systems that rely on combining transmitted repetitions of information may benefit from interference removal techniques, such as those that provide pre-combiner interference removal.

Description of the Related Art

EC-EGPRS is an evolution of EGPRS system to serve as cellular IOT radio interface for GSM/EDGE based systems which have large amount of deployed base stations.

A benefit this new system is higher energy efficiency for low throughput operations and extended coverage benefits. The extended coverage is achieved by introduction of new logical channels. These new logical channels use physical layer blind repetitions at transmission and IQ combining prior to channel estimation at the receiver side to achieve additional coverage gain.

When a system achieves the extended coverage by blind repetitions and receiver combining before channel estimation, the following situation can arise.

When the interference components are added prior to channel estimation, the correlation property is lost. Thus, the classical interference rejection mechanism after channel estimation performance is degraded.

When EC-EGPRS repetitions span across multiple time-slots, each time-slot may experience different interference from neighboring GSM base stations. Interference cancellation of these type of interference is also challenge for CIoT system.

The Cellular IoT receiver of EC-GSM may need to perform blind IQ combination until the effective signal to noise ratio (SNR) has improved to the point where the legacy receiver chain, including estimation and equalization blocks, can be activated. This is viewed as a fundamental mechanism for EC-GSM to achieve extended coverage. To support blind IQ combining, the CiOT receiver may apply co-phasing of interference free Rx branches prior to channel impulse response estimation to combat the phase variations that can arise due to propagation medium.

An EC-GSM device may be designed to operate at lower SINR conditions than current GPRS Rxlevels. The EC-GSM device may use coherent IQ combining of multiple transmissions to achieve the required coverage performance at these levels. The IQ combining mechanism combines the signals at the receiver front-end itself to have improved SINR performance.

Under high interference conditions, the IQ combining mechanism will also add the interference constructively. Moreover, the interference from legacy GSM/GPRS users may be different across time-slots that the EC-GSM receiver is supposed to combine. This may also impact the performance of noise-whitening which is performed after channel estimation.

### SUMMARY

According to certain embodiments, a method can include receiving, from a transmitter, multiple repetitions of a same information sent from the transmitter over a channel. The method can also include removing interference from the respective repetitions. The method can further include combining the interference-removed repetitions. The method can additionally include performing channel estimation based on the combined interference-removed repetitions. The method can also include retrieving information corresponding to the same information sent in the multiple repetitions based on the channel estimation and combined interference-removed repetitions.

In certain embodiments, an apparatus can include means for receiving, from a transmitter, multiple repetitions of a same information sent from the transmitter over a channel. The apparatus can also include means for removing interference from the respective repetitions. The apparatus can further include means for combining the interference-removed repetitions. The apparatus can additionally include means for performing channel estimation based on the combined interference-removed repetitions. The apparatus can also include means for retrieving information corresponding to the same information sent in the multiple repetitions based on the channel estimation and combined interference-removed repetitions.

An apparatus, according to certain embodiments, can include at least one processor and at least one memory including computer program code. The at least one memory and the computer program code can be configured to, with the at least one processor, cause the apparatus at least to receive, from a transmitter, multiple repetitions of a same information sent from the transmitter over a channel. The at least one memory and the computer program code can also be configured to, with the at least one processor, cause the apparatus at least to remove interference from the respective repetitions. The at least one memory and the computer program code can be configured to, with the at least one processor, cause the apparatus at least to combine the interference-removed repetitions. The at least one memory and the computer program code can additionally be configured to, with the at least one processor, cause the apparatus at least to perform channel estimation based on the combined interference-removed repetitions. The at least one memory and the computer program code can also be configured to, with the at least one processor, cause the apparatus at least to retrieve information corresponding to the same information sent in the multiple repetitions based on the channel estimation and combined interference-removed repetitions.

A non-transitory computer-readable medium can, according to certain embodiments, be encoded with instructions that, when executed in hardware, perform a process. The process can include receiving, from a transmitter, multiple repetitions of a same information sent from the transmitter over a channel. The process can also include removing interference from the respective repetitions. The process can further include combining the interference-removed repetitions. The process can additionally include performing channel estimation based on the combined interference-removed repetitions. The process can also include retrieving information corresponding to the same information sent in the multiple repetitions based on the channel estimation and combined interference-removed repetitions.

A computer program product can, in certain embodiments, encode instructions for performing a process. The process can include receiving, from a transmitter, multiple repetitions of a same information sent from the transmitter over a channel. The process can also include removing interference from the respective repetitions. The process can further include combining the interference-removed repetitions. The process can additionally include performing channel estimation based on the combined interference-removed repetitions. The process can also include retrieving information corresponding to the same information sent in the multiple repetitions based on the channel estimation and combined interference-removed repetitions.

### BRIEF DESCRIPTION OF THE DRAWINGS

For proper understanding of the invention, reference should be made to the accompanying drawings, wherein:

FIG. 1 illustrates a receiver according to certain embodiments.

FIG. 2 illustrates a method of receiver processing according to certain embodiments.

FIG. 3 illustrates a comparison between certain embodiments and a comparative example, with respect to carrier to interference ratio as a function of block error rate.

FIG. 4 illustrates a comparison between certain embodiments and a comparative example, with respect to energy per signal to noise spectrum density ratio as a function of block error rate.

FIG. 5 illustrates a comparison amongst certain embodiments and two comparative examples, with respect to carrier to interference ratio as a function of block error rate (BLER).

FIG. 6 illustrates a method according to certain embodiments.

FIG. 7 illustrates another comparison between certain embodiments and a comparative example, with respect to carrier to interference ratio as a function of block error rate.

FIG. 8 illustrates a further comparison between certain embodiments and a comparative example, with respect to carrier to interference ratio as a function of block error rate.

FIG. 9 illustrates a further method according to certain embodiments.

FIG. 10 illustrates a system according to certain embodiments.

### DETAILED DESCRIPTION

Certain embodiments may address the above-described scenarios and avoid or limit the issues related to interference in the case of physical layer blind repetition. Certain embodiments may be particularly relevant to cases where there is a low signal to interference noise ratio (SINR).

For example, certain embodiments may de-correlate noise without relying on the channel impulse response and training sequence symbols. For example, certain embodiments may de-correlate the received signal in space and time domain for every burst. Such de-correlation may, in turn, de-correlate the components in it. Thus, the interference can be de-correlated automatically.

More particularly, certain embodiments can relate to a system in which a transmitter sends the same information multiple times over a channel and the receiver combines these repetitions prior to channel estimation. The method, according to certain embodiments, can include removing the interference at the receiver before combining and prior to channel estimation.

The receiver mentioned here can be provided in an access node, such as a base station, or in a user equipment, such as a mobile station. The receiver can include one or more receive antennas. Although some embodiments are illustrated as though receiving from multiple transmitter elements, such embodiments are merely illustrative and not limiting.

Certain embodiments can apply the above-mentioned interference removal selectively on specific bursts based on estimation of an interference level. This aspect of conditional selective removal of interference can maximize the receiver performance for various interference conditions, from a no-interference scenario to some or all bursts having interference.

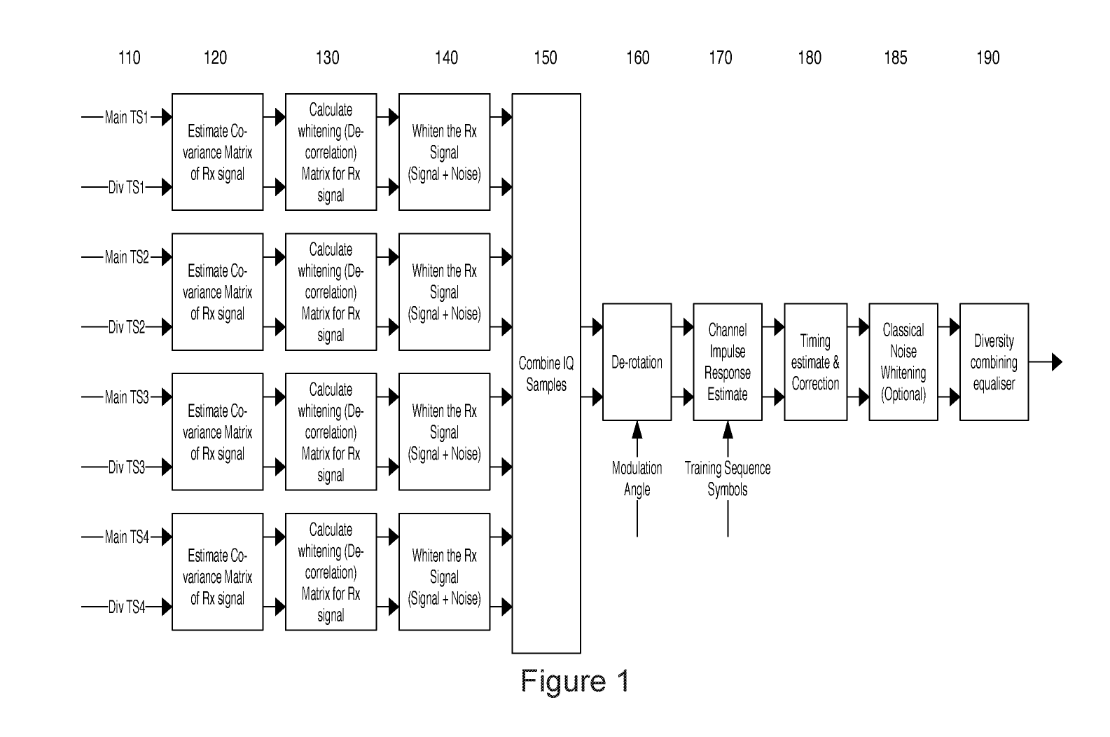

FIG. 1 illustrates a receiver according to certain embodiments. As shown in FIG. 1, a receiver can, at 110, receive transmissions in the form of a coherently transmitted 2-way diversity CiOT system with 4 repetitions, as shown. TS1, TS2, TS3 and TS4 are the bursts transmitted on different time slots. These time slots can be within a frame or across the frames. The “main” and “div” can indicate the main transmission and the diversity transmission for each of the four repetitions.

Although coherence transmission is assumed for illustration purpose, coherence transmission is not necessary. For example, blind whitening (discussed below) can be used even without coherent transmission. Blind whitening does not depend on the transmission mode and any other assumptions made on the transmitter.

At 120, for each of the repetitions, the receiver can estimate a covariance matrix of the received (Rx) signal. Then, at 130, the receiver can calculate a whitening or de-correlation matrix for the received signal. The whitening matrix estimate does not require channel impulse response and training sequence symbols.

After that, at 140, the receiver can whiten the received signal. The whitened signal plus noise can be IQ combined at 150. After that combination, there can be de-rotation using modulation angle information at 160.

Next, using information from training sequence symbols, there can be a channel impulse response estimate at 170. Timing estimate and correction can follow at 180. Optionally, at 185, the receiver can perform classical noise whitening. Finally, at 190, the receiver can apply a diversity combining equalizer. Additional receiver steps not shown can also be performed. The identified steps are for purposes of illustration in the case of a receiver pre-processing chain of an EGPRS system.

One reason that the classical noise whitening at 185 is optional is that it may be unnecessary in view of the new noise removal processing that is performed prior to IQ combining.

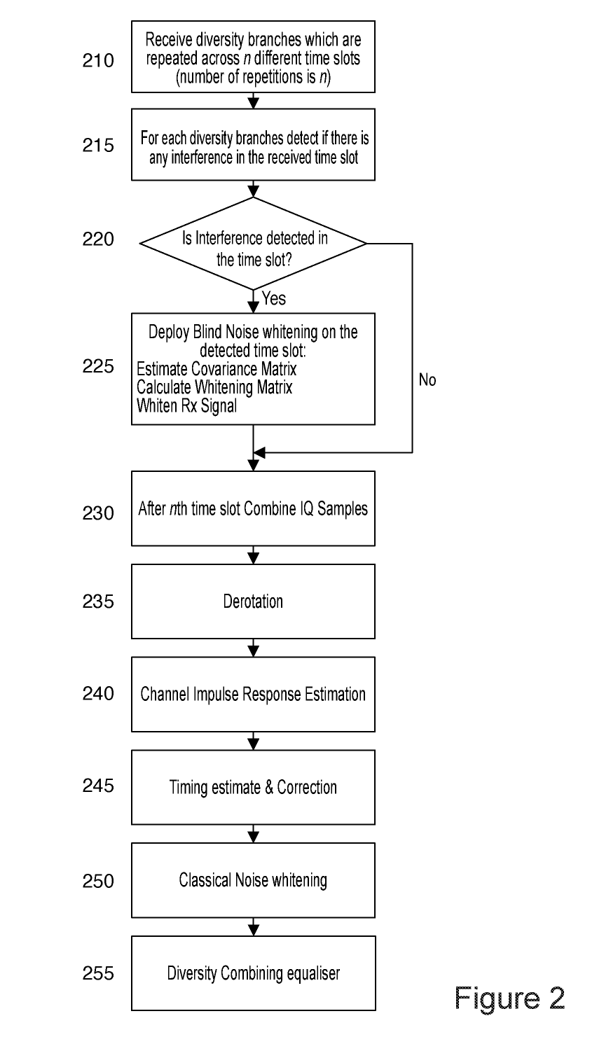

FIG. 2 illustrates a method of receiver processing according to certain embodiments. As shown in FIG. 2, a method can include, at 210, receiving diversity branches that are repeated across n different time slots. Thus, the number of repetitions may be n, and n may be an integer greater than 1.

At 220, for each diversity branch, the method can include detecting if there is any interference in the received time slot. At 220, the method can branch based on whether interference is detected, the method can proceed to, at 225, employing blind noise whitening on the time slot for which interference is detected. This blind noise whitening process can include estimating a covariance matrix, calculating a whitening matrix, and whitening the received signal. If interference is not detected at this time slot, the blind noise whitening may be skipped.

After the nth time slot has been considered, the method can then proceed to, at 230, combining IQ samples. Next, the method can involve derotation of the combined samples at 235 and channel impulse response estimation at 240.

Timing estimate and correction can occur at 245 while optionally classical noise whitening can occur at 250. As mentioned with reference to FIG. 1, classical noise whitening may be an optional step, as there may not be a need for this processing in view of the processing at 225 or the lack of determined interference. Subsequently, at 255, there can be a diversity combining equalization step. Other processing steps are also permitted, with the above-mentioned steps being presented for the sake of illustration.

The carrier to interference ratio (C/I) performance of A CIoT receiver in AN interference scenario with and without blind whitening shows that the CIoT receiver with blind whitening performs significantly better than a normal CIoT receiver.

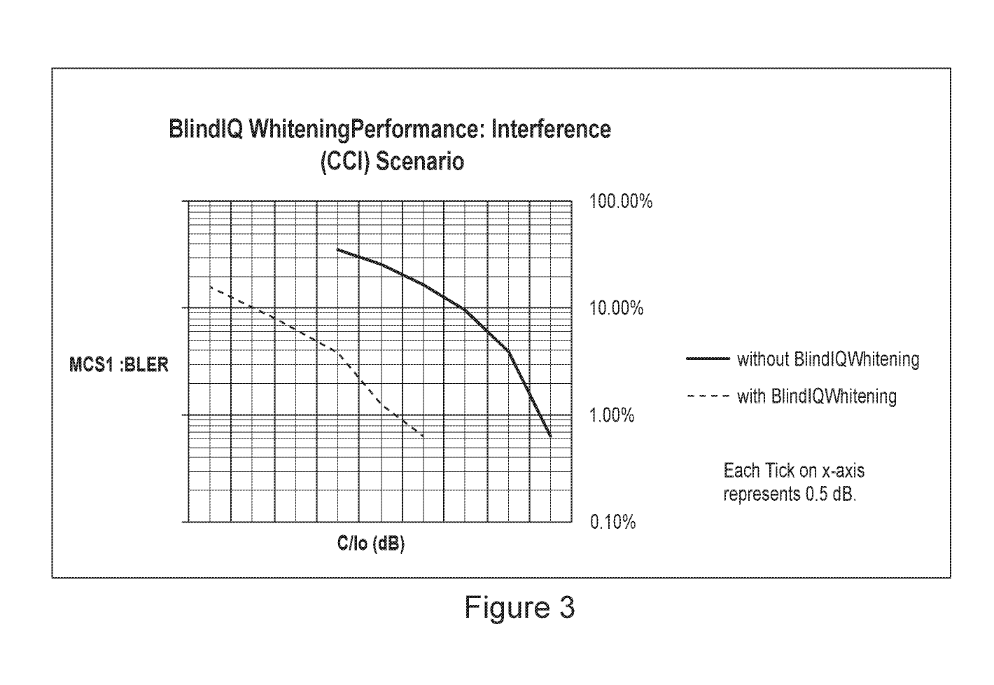

FIG. 3 illustrates a comparison between certain embodiments and a comparative example, with respect to carrier to interference ratio as a function of block error rate (BLER). Thus, FIG. 3 provides a link level C/I performance comparison. As shown in FIG. 3, the use of blind whitening in this simulation example provided a significant decrease in carrier to interference ratio for a wide range of block error rate. Thus, certain embodiments may outperform similar systems that lack blind whitening.

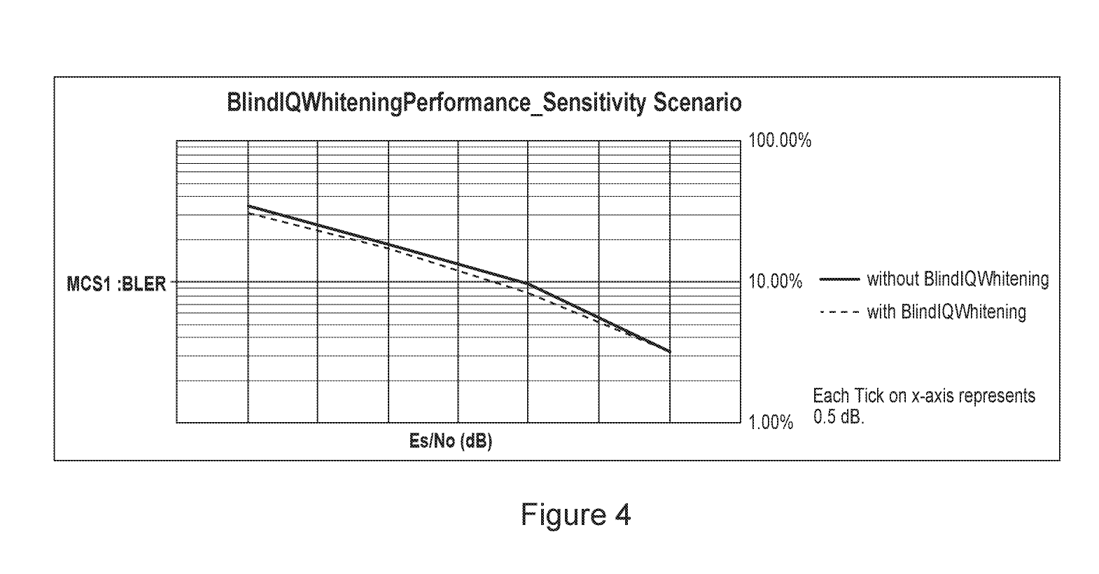

FIG. 4 illustrates a comparison between certain embodiments and a comparative example, with respect to energy per signal to noise spectrum density ratio (Es/No) as a function of block error rate. As can be seen from FIG. 4, over a similar range of block error rates, the Es/No with blind whitening is very close to the Es/No without blind whitening. FIG. 4 illustrates that, according to this simulation data, inclusion of blind whitening may not significantly affect the sensitivity performance of the system.

In certain embodiments, the method may be implemented within a receiver component without any external interface changes. Moreover, this mechanism may bring in additional improvement for CIoT receivers base performance against interference scenario.

The improvement can be seen by, for example, performing a test. The following simulation provides an example. In the simulation, a C/I scenario can be run for an existing GPRS device and for an EC-GRPS (IoT) device.

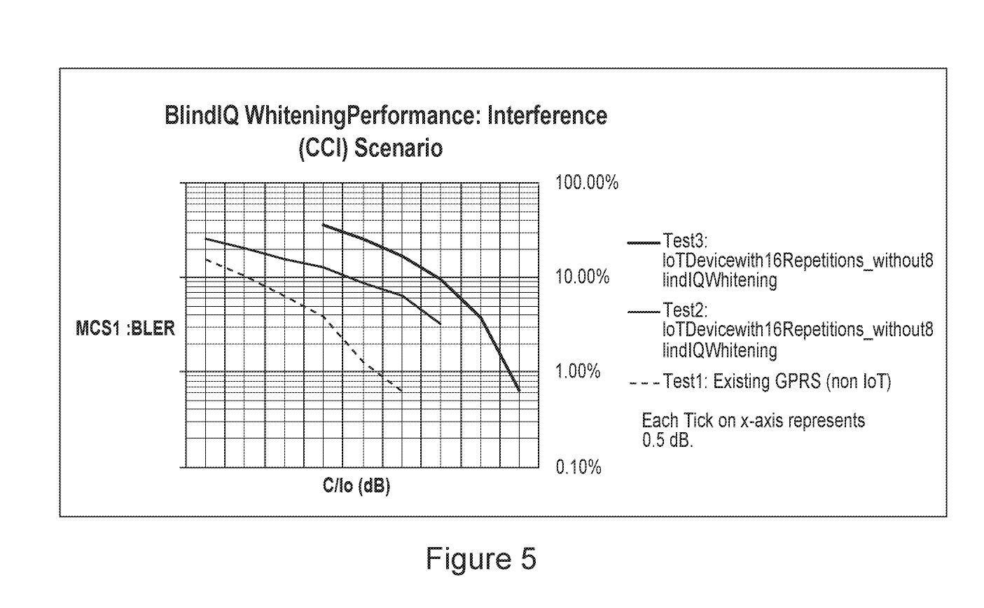

FIG. 5 illustrates a comparison amongst certain embodiments and two comparative examples, with respect to carrier to interference ratio as a function of block error rate (BLER). As can be seen from FIG. 5, the performance of a GPRS device may lie in the middle between an IoT device with blind whitening and an IoT device without blind whitening. Thus, certain embodiments may be distinguished from IoT device without blind whitening by comparing the performance of the device to see if it improves or degrades from GPRS to EC-GPRS. Thus, certain embodiments may be indirectly seen through the improvement that can be provided not only compared to other EC-GPRS devices, but also compared to GPRS devices.

The following provides an example of how noise can be de-correlated without relying on a channel impulse response and/or a noise covariance estimation. This method and variations thereon can be referred to as blind noise whitening.

A received signal of 2-way diversity can be modelled as:

$$\begin{matrix}{y}_{M} ( n ) = {\sum }_{k = 0}^{L - 1} {h}_{M} ( k ) x ( n - k ) + {w}_{M} ( n ) & ( 1 ) \\ {y}_{D} ( n ) = {\sum }_{k = 0}^{L - 1} {h}_{D} ( k ) x ( n - k ) + {w}_{D} ( n ) & ( 2 )\end{matrix}$$

In equations (1) and (2), y_{M}(n) can refer to the received signal of a main branch, x(n) can refer to the transmitted data symbols, n can indicate a time index, L can denote the length of the channel, w_{M}(n) can denote the interfering signal of the main branch, y_{D}(n) can denote the received signal of a diversity branch, and w_{D}(n) can denote the interfering signal of the diversity branch.

The following assumptions may be made: the message is a stationary white message x(n) of zero mean with unit variance E[x(n)x(n−i)*]=δ(i); and the interfering signals, w_{M}(n) and w_{D}(n), are not white. This contains white noise (AWGN) as well as interference that is common to both main and diversity reception (Rx) branches.

The main and diversity samples can be written into a matrix form:

y=Xh+w (3)

In equation 3, h can be an L×2 channel impulse response matrix representing main and diversity Rx paths, X can be an M×L convolution matrix containing the transmitted data symbols, M can denote the length of a received signal vector, y can be an M×2 matrix containing the received signal vectors of main and diversity branches, and w can be an M×2 matrix containing the interference signals of main and diversity branches.

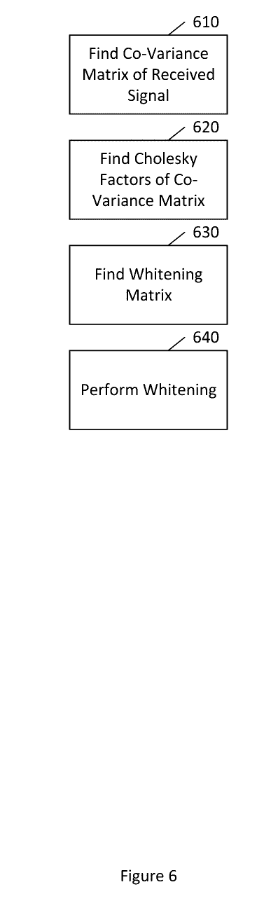

Accordingly, in certain embodiments, a method can include the following steps, as illustrated in FIG. 6. First, at 610, the method can include finding a co-variance matrix of y, R_{yy}=y^{H}y. Next, the method can include finding Cholesky factors of R_{yy}, TT^{H}=R_{yy}, at 620. At 630, the method can include fining whitening matrix Z=T⁻¹Z. Additionally, the method can include, at 640, performing whitening on the received signal matrix y_{w}=yZ.

In certain embodiments, after the above steps 610 through 640, an interference component of w will be removed from the received signal while the wanted signal will be preserved.

If interference is dominating the signal space, such whitening can effectively whiten the interference, and thus combat the interference. If there is no interference, and the system is operated at low SINR the noise can keep the signal rather white. Thus, whitening may not provide significant negative impacts, as illustrated by the examples above.

The method described was verified through simulation for 2-way diversity receiver with noise and interference. The gain (with and without interference cancellation) is observed to be significant. For MCS1, TU3nFH 900 MHz scenario there was 5 dB gain with a method including whitening compared to a MRC with no whitening.

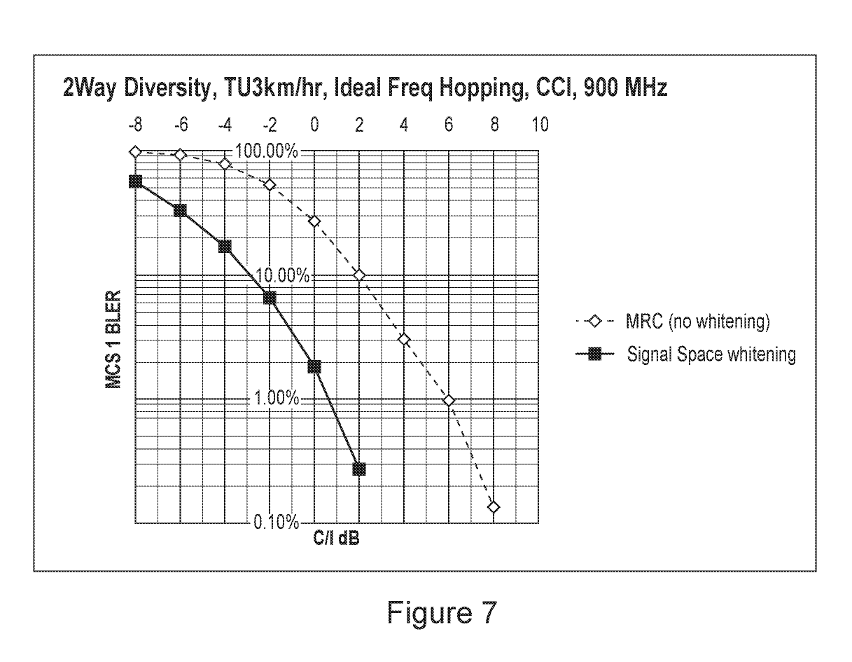

FIG. 7 illustrates a comparison between certain embodiments and a comparative example, with respect to carrier to interference ratio as a function of block error rate. FIG. 7 illustrates interference gain that can be achieved for MCS1: 2-way diversity, TU3nFH 900 MHz with co-channel interference. As shown in FIG. 7, whitening can provide an improvement.

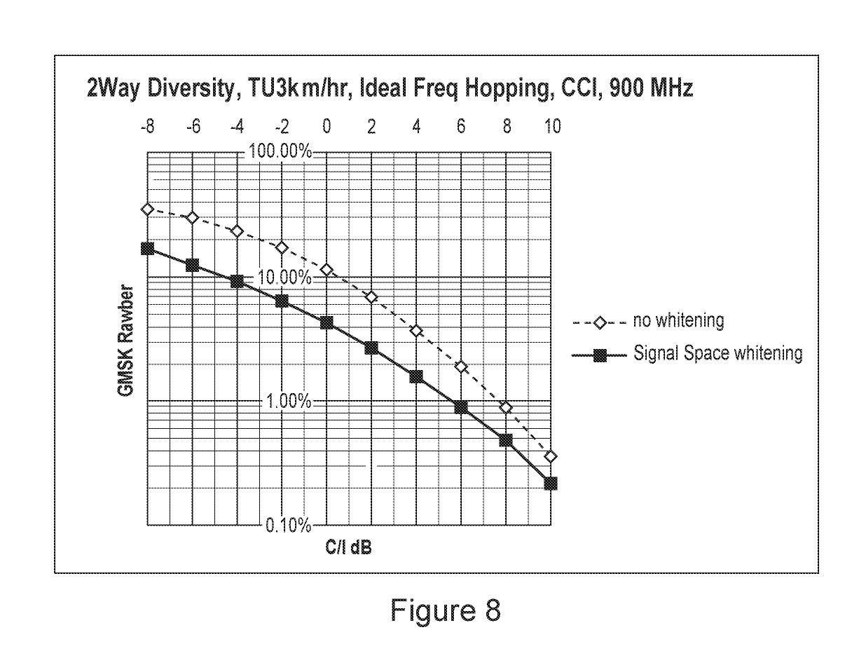

FIG. 8 illustrates a further comparison between certain embodiments and a comparative example, with respect to carrier to interference ratio as a function of block error rate. FIG. 8 illustrates the interference gain that can be achieved for GMSK Rawber: 2-way diversity, TU3nFH 900 MHz with co-channel interference. As shown in FIG. 8, whitening can provide an improvement even in this case.

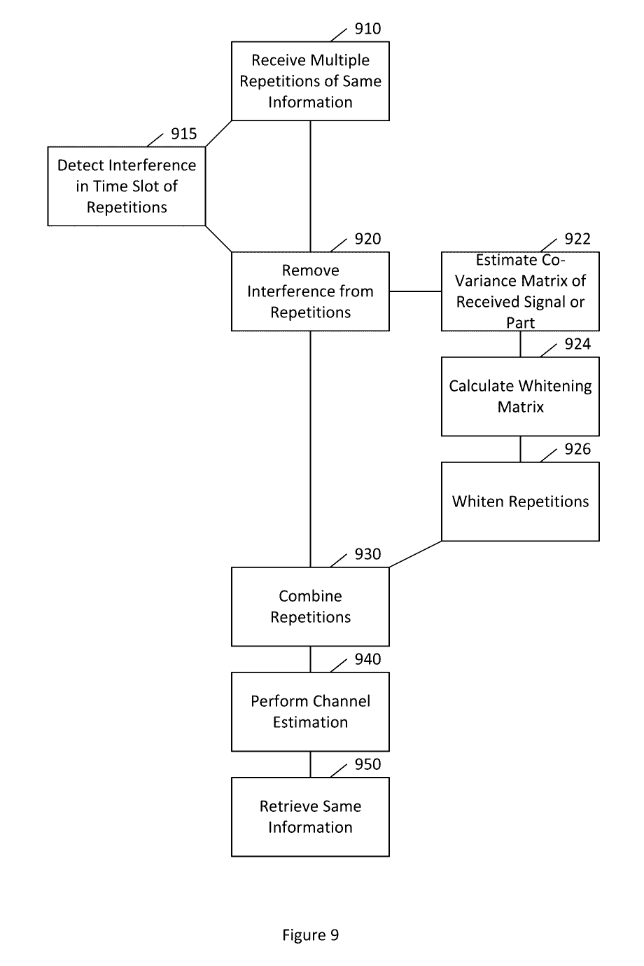

FIG. 9 illustrates a further method according to certain embodiments. As shown in FIG. 9, a method can include, at 910, receiving, from a transmitter, multiple repetitions of a same information sent from the transmitter over a channel. The repetitions can be physical layer blind repetitions. Moreover, the repetitions can span a plurality of time slots.

The method can also include, at 920, removing interference from the respective repetitions. The removing can be based on estimation of an interference level applicable to at least one specific burst of transmission from the transmitter.

The removing can include, at 922, respectively estimating a co-variance matrix based on either a segment or a whole received signal of each of the repetitions. The removing can also include, at 924, calculating a whitening matrix for each of the repetitions. The removing can further include, at 926, respectively whitening each of the repetitions.

The removing can be based on previously detecting, at 915, interference in a respective time slot for the respective repetition.

The method can further include, at 930, combining the interference-removed repetitions. The combining can include combining IQ samples of the repetitions.

The method can additionally include, at 940, performing channel estimation based on the combined interference-removed repetitions. Thus, the channel estimation at 940 can be performed after the interference is removed at 920 with respect to a given set of repetitions.

The method can also include, at 950, retrieving information corresponding to the same information sent in the multiple repetitions based on the channel estimation and combined interference-removed repetitions. The method can be performed using digital signal processing operating on hardware and stored in a non-transitory computer-readable medium. This retrieval of information may be omitted in certain embodiments, as the retrieval of information may take place in subsequent processing.

The method of FIG. 9 may be performed by any device configured to receive such repetitions, including an access node, such as a base station, access point, or the like, or a user equipment, such as a mobile unit.

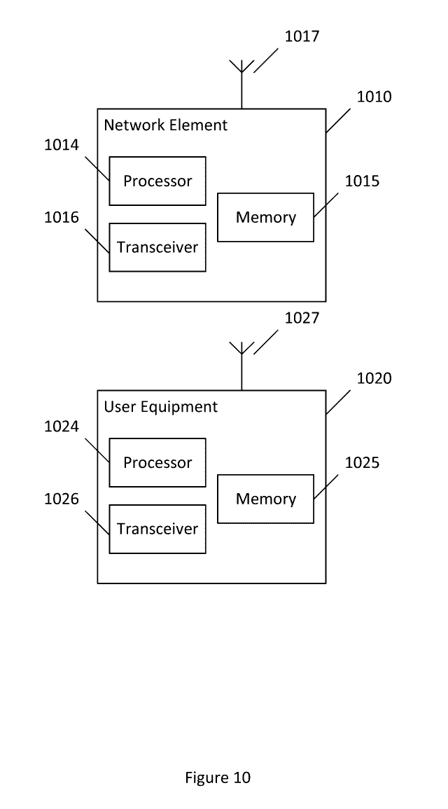

FIG. 10 illustrates a system according to certain embodiments of the invention. It should be understood that each block of the flowchart of FIG. 9 may be implemented by various means or their combinations, such as hardware, software, firmware, one or more processors and/or circuitry. In one embodiment, a system may include several devices, such as, for example, network element 1010 and user equipment (UE) or user device 1020. The system may include more than one UE 1020 and more than one network element 1010, although only one of each is shown for the purposes of illustration. A network element can be an access point, a base station, an eNode B (eNB), or any other network element.

Each of these devices may include at least one processor or control unit or module, respectively indicated as 1014 and 1024. At least one memory may be provided in each device, and indicated as 1015 and 1025, respectively. The memory may include computer program instructions or computer code contained therein, for example for carrying out the embodiments described above. One or more transceiver 1016 and 1026 may be provided, and each device may also include an antenna, respectively illustrated as 1017 and 1027. Although only one antenna each is shown, many antennas and multiple antenna elements may be provided to each of the devices. Other configurations of these devices, for example, may be provided. For example, network element 1010 and UE 1020 may be additionally configured for wired communication, in addition to wireless communication, and in such a case antennas 1017 and 1027 may illustrate any form of communication hardware, without being limited to merely an antenna.

Transceivers 1016 and 1026 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. It should also be appreciated that according to the “liquid” or flexible radio concept, the operations and functionalities may be performed in different entities, such as nodes, hosts or servers, in a flexible manner. In other words, division of labor may vary case by case.

A user device or user equipment 1020 may be a mobile station (MS) such as a mobile phone or smart phone or multimedia device, a computer, such as a tablet, provided with wireless communication capabilities, personal data or digital assistant (PDA) provided with wireless communication capabilities, portable media player, digital camera, pocket video camera, navigation unit provided with wireless communication capabilities or any combinations thereof. The user device or user equipment 1020 may be a sensor or smart meter, or other device that may usually be configured for a single location.

In an exemplifying embodiment, an apparatus, such as a node or user device, may include means for carrying out embodiments described above in relation to FIG. 9.

Processors 1014 and 1024 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors. Additionally, the processors may be implemented as a pool of processors in a local configuration, in a cloud configuration, or in a combination thereof.

For firmware or software, the implementation may include modules or unit of at least one chip set (e.g., procedures, functions, and so on). Memories 1015 and 1025 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 1010 and/or UE 1020, to perform any of the processes described above (see, for example, FIG. 9). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 10 illustrates a system including a network element 1010 and a UE 1020, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

Certain embodiments may have various benefits and/or advantages. For example, certain embodiments of a method can be used with single antenna based system as well as with multiple antenna based systems. For example, the method can be used in mobile stations for better downlink interference performance as well with base stations for better uplink interference performance.

Certain embodiments of the method can be used to cancel any number of interferer of any type. These interferers may have a different modulation and may be asynchronous with respect to the signal of interest to the receiver.

Certain embodiments of the method can, as noted above, improve the the interference performance of the EC-EGPRS system. Moreover, certain embodiments may be a feature of EC-EGPRS that can help to provide reduced spectrum deployment with tighter frequency reuse.

When IOT system using other technologies such as NB-LTE/5G the same method can be applied for interference removal. Thus, certain embodiments are not necessarily limited to EC-EGPRS reusing LTE.

Certain embodiments can be implemented in digital signal processing (DSP). The whitening matrix can be estimated blindly from the whole or a sub-set of a received burst without the need of training symbols and without the need of a channel impulse response estimation.

Certain embodiments can be extended for interference scenarios with higher Rxlevel conditions, as well as for tighter reuse scenarios. In these conditions the EC-GSM device can be configured to use IQ combining at higher receive-level than current RxlevMin, which may help to overcome the interference using IQ combining. In such situations, noise whitening can be provided as part of, or prior to, IQ combining rather than after channel estimation.

Thus, certain embodiments may provide interference rejection that can be applied on Rx branches prior to co-phasing and channel impulse response estimation.

Additionally, certain embodiments may be suitable for machine-to-machine type low rate, low power communications, although certain embodiments can be applied to many other categories of devices.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### LIST OF ABBREVIATIONS

EC-GSM: Extended Coverage GSM

IoT: Internet of Things

MMSE: Minimum Mean Square Error

MRC: Maximum Ratio Combining

Rx: Received

SINR: Signal to Interference and Noise Ratio

TS: Time Slot

1. A method of retrieving information from multiple received repetitions, comprising:
receiving, from a transmitter, multiple repetitions of a same information sent from the transmitter over a channel, wherein respective repetitions comprise interference;
removing the interference from the respective repetitions;
combining the interference-removed repetitions;
performing channel estimation based on the combined interference-removed repetitions; and
retrieving information corresponding to the same information sent in the multiple repetitions based on the channel estimation and combined interference-removed repetitions.

2. The method of claim 1, wherein the removing is based on estimation of an interference level applicable to at least one specific burst of transmission from the transmitter.

3. The method of claim 1, wherein the removing comprises respectively estimating a co-variance matrix based on either a segment or a whole received signal of each of the repetitions.

4. The method of claim 1, wherein the removing comprises respectively calculating a whitening matrix for each of the repetitions.

5. The method of claim 1, wherein the removing comprises respectively whitening each of the repetitions.

6. The method of claim 1, wherein the repetitions comprise physical layer blind repetitions.

7. The method of claim 1, wherein the repetitions span a plurality of time slots.

8. The method of claim 1, wherein the combining comprises combining IQ samples of the repetitions.

9. The method of claim 1, wherein the removing comprises removing the interference based on previously detecting interference in a respective time slot for the respective repetition.

10. The method of claim 1, wherein the method is performed in an access node or a user equipment.

11. The method of claim 1, wherein the method is performed using digital signal processing operating on hardware.

12. An apparatus, comprising:
means for performing the method according to claim 1.

13. An apparatus, comprising:
at least one processor; and
at least one memory including computer program code,
wherein the at least one memory and the computer program code are configured to, with the at least one processor, cause the apparatus at least to:
receive, from a transmitter, multiple repetitions of a same information sent from the transmitter over a channel;
remove interference from the respective repetitions;
combine the interference-removed repetitions;
perform channel estimation based on the combined interference-removed repetitions; and
retrieve information corresponding to the same information sent in the multiple repetitions based on the channel estimation and combined interference-removed repetitions.

14. A non-transitory computer-readable medium encoded with instructions that, when executed in hardware, perform a process, the process comprising the method according to claim 1.

15. A non-transitory computer-readable medium comprising a computer program product encoding instructions for performing a process, the process comprising the method according to claim 1.
